(19) United States
(12) Patent Application Publication
(10) Pub. No.: US 2005/0156924 A1
(43) Pub. Date: Jul. 21, 2005

(54) Voltage booster circuit, power supply circuit, and liquid crystal driver

(75) Inventor: Motoaki Nishimura, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/024,736

(22) Filed: Dec. 30, 2004

(30) Foreign Application Priority Data
Jan. 20, 2004 (JP) 2004-012115

(51) Int. Cl. G09G 5/00

(52) U.S. Cl. 345/211

(57) ABSTRACT

A charge-pump circuit includes: MOS transistors connected in series and having one end to which a system ground power supply voltage is supplied; and first to fifth discharge transistors having one end connected to the system ground power supply voltage and the other end connected to the MOS transistors. The MOS transistors are implemented by a triple-well structure formed in a p-type semiconductor substrate. When a discharge operation is performed, the first to fifth discharge transistors are separately ON/OFF controlled, thereby preventing parasitic bipolar transistor elements from being Darlington-connected and preventing a current path from being formed.

Japanese Patent Application No. 2004-12115, filed on Jan. 20, 2004, is hereby incorporated by reference in its entirety.

### BACKGROUND OF THE INVENTION

The present invention relates to a voltage booster circuit, a power supply circuit, and a liquid crystal driver.

A further reduction of power consumption is required for a portable electronic instrument. A liquid crystal device is generally used as a display device provided in such an electronic instrument.

A high voltage is necessary for driving the liquid crystal device. Therefore, it is preferable from the viewpoint of cost that a liquid crystal driver which drives the liquid crystal device include a power supply circuit which generates a high voltage. In this case, the power supply circuit includes a voltage booster circuit. A reduction of power consumption can be achieved by using a charge-pump circuit which generates a voltage boosted by a charge-pump operation as the voltage booster circuit.

The charge-pump circuit (voltage booster circuit in a broad sense) connects one end of a capacitor which stores an electric charge with various voltages using a switch element (metal oxide semiconductor (MOS) transistor, for example), thereby boosting the voltage corresponding to the electric charge stored in the capacitor. Therefore, the electric charge stored in the capacitor during the operation is maintained even if the operation of the charge-pump circuit is terminated.

A liquid crystal which makes up a pixel of the liquid crystal device deteriorates when a DC component voltage is applied to the liquid crystal. Therefore, when terminating the operation of the charge-pump circuit which generates the voltage for the liquid crystal device, the voltage applied to the liquid crystal must be controlled by performing a discharge operation according to a predetermined sequence.

However, in the case where a MOS transistor which makes up the charge-pump circuit is formed on a semiconductor substrate using a triple-well structure, a parasitic bipolar transistor element may be turned ON during the discharge operation, whereby an undesired overcurrent may occur.

### BRIEF SUMMARY OF THE INVENTION

According to a first aspect of the present invention, there is provided a voltage booster circuit which uses an electric charge stored in a capacitor by a charge-pump operation to generate a boost voltage, the voltage booster circuit comprising:
first to Nth transistors (N is an integer greater than one) which are connected in series and used for the charge-pump operation, a first voltage being supplied to one end of the first transistor; and
first to Nth discharge transistors used for discharging an electronic charge stored in capacitors connected to the first to Nth transistors, a discharge voltage being supplied to one end of each of the first to Nth discharge transistors, and the other end of each of the first to Nth discharge transistors being connected to a source side or a drain side of the kth transistors among the first to Nth transistors (1≦k ≦N, k is an integer),
wherein the first to Nth transistors are respectively formed in first to Nth well regions of a first conductivity type formed in a well region of a second conductivity type in a semiconductor substrate of the first conductivity type;
wherein a reverse bias voltage for the first to Nth well regions is applied to the well region of the second conductivity type;
wherein each of the first to Nth well regions includes source and drain regions of the second conductivity type;
wherein a gate electrode of each of the first to Nth transistors is disposed on a channel region with an insulating film interposed, the channel region being disposed between the source and drain regions;
wherein the first voltage is supplied to the drain region or the source region of the first well region, the drain region or the source region of an (m-1)th well region (2≦m≦N, m is an integer) among the first to Nth well regions is electrically connected to the source region or the drain region of the mth well region, and a voltage of the drain region or the source region of the Nth well region is output as the boost voltage; and
wherein, when a discharge operation is performed, the first to Nth discharge transistors are separately made conductive or nonconductive.

According to a second aspect of the present invention, there is provided a power supply circuit, comprising:
the above-described voltage booster circuit; and
a voltage polarity reversal circuit which reverses the polarity of the boost voltage based on a voltage between the first voltage and a second voltage,
wherein the power supply circuit outputs the first voltage, the second voltage, the boost voltage, and a voltage obtained by reversing the polarity of the boost voltage.

According to a third aspect of the present invention, there is provided a liquid crystal driver, comprising:
the above-described power supply circuit; and
a driver circuit which drives a segment electrode or a common electrode of a simple matrix liquid crystal panel by using at least one of the first voltage, the reverse bias voltage, and the boost voltage.

### BRIEF DESCRIPTION OF THE SEVERAL VIEWS OF THE DRAWING

FIG. 1 is a block diagram showing a liquid crystal device including a liquid crystal driver according to one embodiment of the present invention.

FIG. 2 is a block diagram showing an X driver section.

FIG. 3 is a block diagram showing a Y driver section.

FIG. 4 is a diagram for illustrating the relationship among various liquid crystal drive voltages.

FIG. 5 is a diagram showing an example of waveforms of a COM electrode, SEG electrode, ON pixel, and OFF pixel.

FIG. 6 is a block diagram showing a power supply circuit according to one embodiment of the present invention.

FIGS. 7A and 7B schematically show a charge-pump circuit.

FIG. 8 shows a charge-pump circuit in detail.

FIG. 9 shows two clock signals which provide reference timings for charge clock signals.

FIG. 10 shows a charge clock generation section.

FIG. 11 shows a discharge control section.

FIG. 12 is a truth table of an operation of a decoder shown in FIG. 11.

FIG. 13 shows a voltage polarity reversal circuit shown in FIG. 6.

FIG. 14 shows capacitor connections of a charge-pump circuit in a three-fold boost according to one embodiment of the present invention.

FIG. 15 shows voltage waveforms on the ends of capacitors connected to the charge-pump circuit shown in FIG. 14.

FIG. 16 is a cross-sectional view showing the MOS transistors of FIG. 14 formed in a p-type semiconductor substrate.

FIG. 17 shows Darlington-connection of the parasitic bipolar transistor elements in FIG. 16.

FIG. 18 is a circuit diagram showing a charge-pump circuit formed in an n-type silicon substrate.

FIG. 19 is a cross-sectional view showing the MOS transistors of FIG. 18 formed in an n-type semiconductor substrate.

FIG. 20 shows Darlington-connection of the parasitic bipolar transistor elements in FIG. 19.

### DETAILED DESCRIPTION OF THE EMBODIMENT

The present invention has been achieved in view of the above-described technical problem, and may provide a voltage booster circuit, a power supply circuit, and a liquid crystal driver which reliably prevent occurrence of overcurrent in the discharge operation when MOS transistors for performing the charge-pump operation are implemented by a triple-well structure.

According to one embodiment of the present invention, there is provided a voltage booster circuit which uses an electric charge stored in a capacitor by a charge-pump operation to generate a boost voltage, the voltage booster circuit comprising:
first to Nth transistors (N is an integer greater than one) which are connected in series and used for the charge-pump operation, a first voltage being supplied to one end of the first transistor; and
first to Nth discharge transistors used for discharging an electronic charge stored in capacitors connected to the first to Nth transistors, a discharge voltage being supplied to one end of each of the first to Nth discharge transistors, and the other end of each of the first to Nth discharge transistors being connected to a source side or a drain side of the kth transistors among the first to Nth transistors (1≦k≦N, k is an integer),
wherein the first to Nth transistors are respectively formed in first to Nth well regions of a first conductivity type formed in a well region of a second conductivity type in a semiconductor substrate of the first conductivity type;
wherein a reverse bias voltage for the first to Nth well regions is applied to the well region of the second conductivity type;
wherein each of the first to Nth well regions includes source and drain regions of the second conductivity type;
wherein a gate electrode of each of the first to Nth transistors is disposed on a channel region with an insulating film interposed, the channel region being disposed between the source and drain regions;
wherein the first voltage is supplied to the drain region or the source region of the first well region, the drain region or the source region of an (m-1)th well region (2≦m≦N, m is an integer) among the first to Nth well regions is electrically connected to the source region or the drain region of the mth well region, and a voltage of the drain region or the source region of the Nth well region is output as the boost voltage; and
wherein, when a discharge operation is performed, the first to Nth discharge transistors are separately made conductive or nonconductive.

In this voltage booster circuit,
the first transistor may have one end to which the first voltage is supplied, and apply the first voltage to one end of a first capacitor in a first period, the other end of the first capacitor having a second voltage in the first period and having the first voltage in a second period;
the ith transistor (2≦i≦N, N is an integer greater than two and i is an even number) may have one end connected to one end of an (i-1)th transistor, and connect one end of an ith capacitor to one end of an (i-1)th capacitor in the second period, the other end of the ith capacitor having the first voltage in the first period and having the second voltage in the second period; and
the jth transistor (3≦j≦N, and j is an odd number) may have one end connected to one end of a (j-1)th transistor, and connect one end of a jth capacitor to one end of the (j-1)th capacitor in the first period, the other end of the jth capacitor having the second voltage in the first period and having the first voltage in the second period.

In this voltage booster circuit, a boost voltage obtained by boosting a voltage between the first and second voltages N times can be output by the charge-pump operation using the first to Nth transistors implemented by the triple-well structure and the capacitors connected with these transistors, for example. A boost voltage obtained by boosting a voltage between the first and second voltages (N-1) times can be output by making the Nth transistor conductive and omitting connection of the capacitor which contributes to the charge-pump operation using the Nth transistor. In this case, parasitic bipolar transistor elements are formed in a region in which the first to Nth transistors are formed. If the first to Nth discharge transistors are made conductive at the same time, the first voltage may be applied to a parasitic bipolar transistor element formed in the (N-1)th transistor through the (N-1)th discharge transistor. This causes the parasitic bipolar transistor elements to be Darlington-connected, whereby an overcurrent may occur.

However, since the first to Nth discharge transistors can be separately made conductive or nonconductive when the discharge operation is performed, occurrence of overcurrent can be prevented.

In this voltage booster circuit, when the discharge operation is performed, each of the first to Nth discharge transistors may be made conductive or nonconductive, depending on a boost factor.

The voltage booster circuit may further comprise:
a bias ratio setting register which sets a bias ratio obtained by an amplitude of a common voltage and an amplitude of a segment voltage, the common voltage being applied to a common electrode of a simple matrix liquid crystal panel, and the segment voltage being applied to a segment electrode of the simple matrix liquid crystal panel,
wherein, when the discharge operation is performed, each of the first to Nth discharge transistors may be made conductive or nonconductive based on a value set in the bias ratio setting register.

Since capacitors to be connected differ depending on the bias ratio, occurrence of overcurrent can be reliably prevented even if various bias ratios are set.

In this voltage booster circuit, all of the first to Nth discharge transistors may be made conductive on condition that an initialization signal of the bias ratio setting register has become active and the reverse bias voltage has become equal to or less than a threshold value.

Generating the reverse bias voltage based on the boost voltage makes it possible to perform the discharge operation based on a value set in the bias ratio setting register irrespective of the initialization signal, without initializing the value in the bias ratio setting register, when the reverse bias voltage has not been decreased. When the reverse bias voltage has been decreased, the discharge operation can be performed by the first to Nth discharge transistors.

In this voltage booster circuit, when the discharge operation is performed, only a discharge transistor connected to a capacitor for performing the charge-pump operation may be made conductive among the first to Nth discharge transistors.

In this voltage booster circuit, the discharge voltage may be the first voltage.

According to one embodiment of the present invention, there is provided a power supply circuit, comprising:
the voltage booster circuit as defined in claim 1; and
a voltage polarity reversal circuit which reverses the polarity of the boost voltage based on a voltage between the first voltage and a second voltage,
wherein the power supply circuit outputs the first voltage, the second voltage, the boost voltage, and a voltage obtained by reversing the polarity of the boost voltage.

In this power supply circuit, the voltage obtained by reversing the polarity of the boost voltage may be the reverse bias voltage.

In this power supply circuit,
the first voltage may be one of voltages applied to a segment electrode of a simple matrix liquid crystal panel;
the reverse bias voltage may be one of a high-potential-side voltage and a low-potential-side voltage applied to a common electrode of the liquid crystal panel; and
the boost voltage may be the other of the high-potential-side voltage and the low-potential-side voltage.

This power supply circuit can reliably prevent occurrence of overcurrent even if the power supply circuit includes a voltage booster circuit having a triple-well structure for the charge-pump operation.

According to one embodiment of the present invention, there is provided a liquid crystal driver, comprising:
the power supply circuit as defined in claim 8; and
a driver circuit which drives a segment electrode or a common electrode of a simple matrix liquid crystal panel by using at least one of the first voltage, the reverse bias voltage, and the boost voltage.

This makes it possible to provide a liquid crystal driver including a power supply circuit which reliably prevent occurrence of overcurrent and generates a liquid crystal drive voltage at low cost with low power consumption.

These embodiments will be described in detail with reference to the drawings. Note that the embodiments described below do not in any way limit the scope of the invention laid out in the claims herein. In addition, not all of the elements of the embodiments described below should be taken as essential requirements of the present invention.

1. Liquid Crystal Device

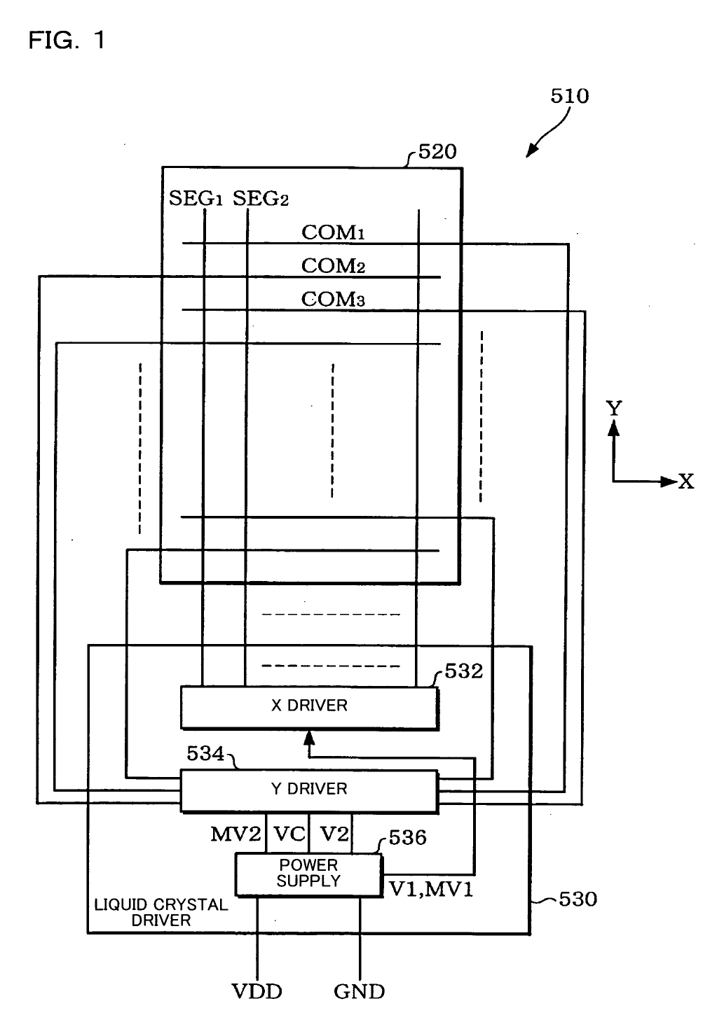

FIG. 1 is a block diagram showing a liquid crystal device including a liquid crystal driver according to one embodiment of the present invention.

A liquid crystal device 510 includes a liquid crystal panel 520 and a liquid crystal driver 530.

The liquid crystal panel 520 includes a plurality of COM electrodes (common electrodes) (scan lines in a narrow sense), a plurality of SEG electrodes (segment electrodes) (data lines in a narrow sense), and pixels specified by the COM electrodes and the SEG electrodes. The liquid crystal panel 520 is a simple matrix liquid crystal panel.

In more detail, the liquid crystal panel 520 is formed on a panel substrate (glass substrate, for example). A plurality of COM electrodes COM₁ to COM_{M} (M is a natural number greater than one), arranged in a direction Y shown in FIG. 1 and extending in a direction X, and a plurality of SEG electrodes SEG₁ to SEG_{N} (N is a natural number greater than one), arranged in the direction X and extending in the direction Y, are disposed on the panel substrate. A pixel is formed at a position corresponding to the intersecting point of the COM electrode COM_{K} (1≦K≦M, K is a natural number) and the SEG electrode SEG_{L} (1≦L≦N, L is a natural number). Each pixel is formed by sealing a liquid crystal between the COM electrode and the SEG electrode, and the transmissivity of each pixel changes corresponding to the voltage applied between the COM electrode and the SEG electrode.

In the liquid crystal panel 520, the COM electrodes are alternately disposed from the opposite sides of the panel toward the inside of the panel in units of one COM electrode. The liquid crystal panel 520 is alternately driven from a first side of the liquid crystal panel 520 and a second side opposite to the first side in units of one COM electrode.

The liquid crystal driver 530 includes an X driver section 532, a Y driver section 534, and a power supply circuit 536. The X driver section 532 drives the SEG electrode SEG₁ to SEG_{N} of the liquid crystal panel 520 based on display data. The Y driver section 534 sequentially selects the COM electrodes COM₁ to COM_{M} of the liquid crystal panel 520. The power supply circuit 536 generates a drive voltage of the SEG electrode and a drive voltage of the COM electrode.

The liquid crystal driver 530 operates according to the content set by a host such as a central processing unit (CPU) (not shown) or a controller controlled by the host.

In more detail, the host or controller provides an operation mode setting and a vertical synchronization signal or a horizontal synchronization signal generated therein to the X driver section 532 and the Y driver section 534 of the liquid crystal driver 530, for example. The host or controller controls a boost factor setting and a discharge operation of the power supply circuit 536 of the liquid crystal driver 530, for example.

The power supply circuit 536 generates the drive voltages (V1, MV1, VC).of the SEG electrode and the drive voltages (V2, MV2, VC) of the COM electrode based on a system ground power supply voltage GND supplied from the outside and a system power supply voltage VDD supplied from the outside. The X driver section 532 applies one of the drive voltages V1, MV1, and VC generated by the power supply circuit 536 to the SEG electrode based on the display data. The Y driver section 534 applies one of the drive voltages V2, MV2, and VC generated by the power supply circuit 536 to the COM electrode.

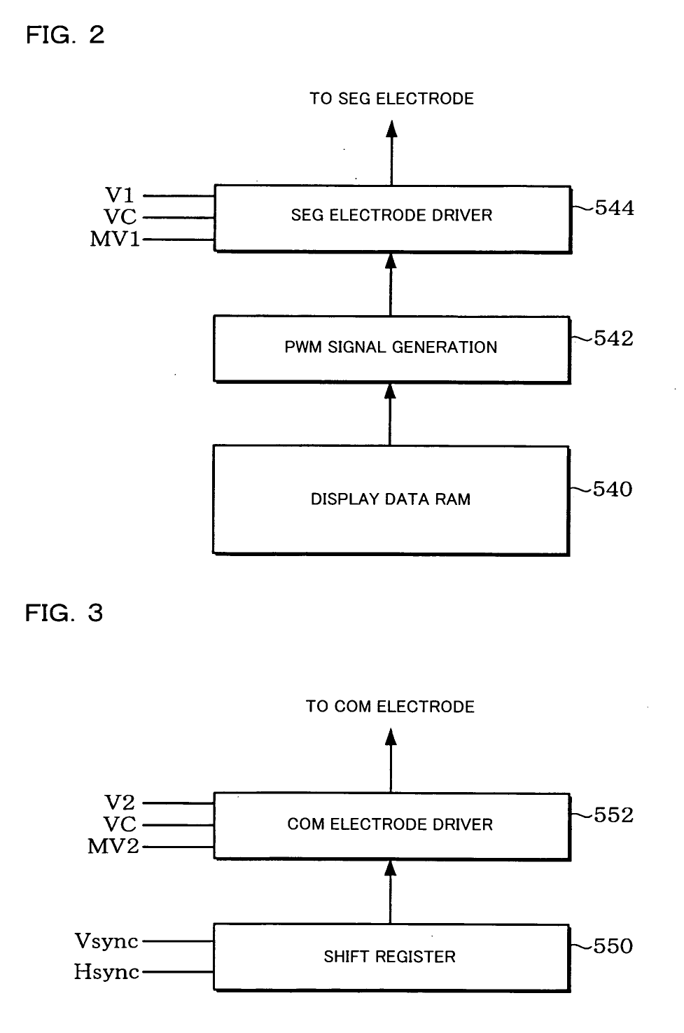

FIG. 2 is a block diagram showing the X driver section 532.

The X driver section 532 includes a display data RAM 540, a pulse width modulation (PWM) signal generation circuit 542, and a SEG electrode driver circuit 544 (driver circuit in a broad sense). The display data RAM 540 stores the display data for one vertical scan period, for example. The PWM signal generation circuit 542 reads the display data for one horizontal scan period from the display data RAM 540, and generates a PWM signal to be applied to the SEG electrode. The SEG electrode driver circuit 544 applies one of the drive voltages V1 and MV1 corresponding to the PWM signal generated by the PWM signal generation circuit 542 to the SEG electrode. The SEG electrode driver circuit 544 may apply the drive voltage VC to the SEG electrode in a non-display region. The drive voltage VC is a voltage in common with the Y driver section 534.

FIG. 3 is a block diagram showing the Y driver section 534.

The Y driver section 534 includes a shift register 550 and a COM electrode driver circuit 552 (driver circuit in a broad sense). The shift register 550 includes a plurality of flip-flops which are provided corresponding to the COM electrodes and sequentially connected. The shift register 550 holds the vertical synchronization signal Vsync in the flip-flop in synchronization with the horizontal synchronization signal Hsync, and sequentially shifts the vertical synchronization signal Vsync to the adjacent flip-flop in synchronization with the horizontal synchronization signal Hsync.

The COM electrode driver circuit 552 converts the level of the voltage from the shift register 550 to the level of one of the drive voltages V2, MV2, and VC. The COM electrode driver circuit 552 outputs the level-converted voltage to the COM electrode. When the COM electrode corresponding to the flip-flop which holds the vertical synchronization signal Vsync shifted in the shift register 550 is selected, one of the drive voltages V2 and MV2 is applied to the COM electrode. The drive voltage VC is applied to the unselected COM electrodes.

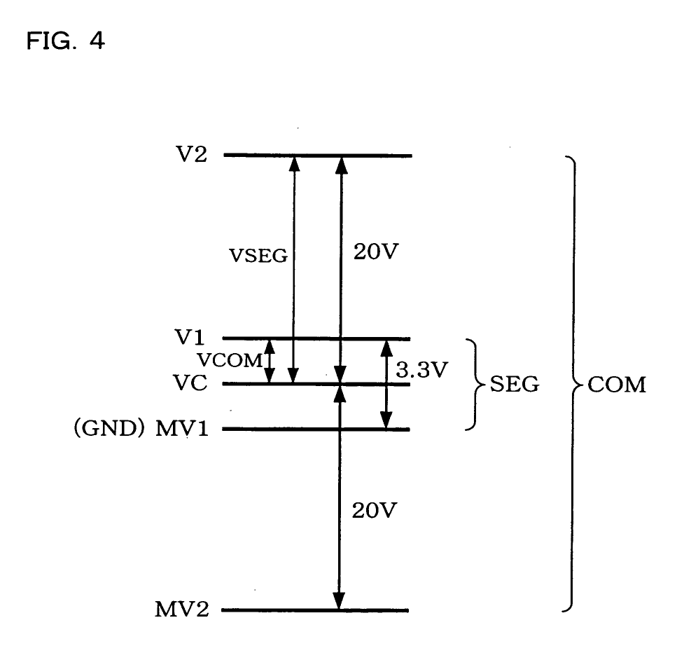

FIG. 4 is a diagram for illustrating the relationship among various liquid crystal drive voltages.

In this embodiment, the drive voltage VC is a voltage which can be commonly applied to the SEG electrode and the COM electrode. The SEG electrode drive voltages V1 and MV1 having the same amplitude in the positive direction and the negative direction are generated based on the drive voltage VC. Specifically, the middle voltage between the SEG electrode drive voltages V1 and MV1 is the drive voltage VC. The drive voltage MV1 may be the system ground power supply voltage GND. The voltage between the drive voltage V1 and the drive voltage MV1 is 3.3 V, for example.

The COM electrode drive voltages V2 and MV2 having the same amplitude in the positive direction and the negative direction are generated based on the drive voltage VC. The voltage between the drive voltage VC and the drive voltage V2 is 20 V, and the voltage between the drive voltage MV2 and the drive voltage VC is 20 V, for example.

In the simple matrix liquid crystal panel 520, the bias ratio may be defined as shown by the following equation (1).
1/bias ratio=(VCOM/VSEG)+1 (1)

The voltage VCOM is the voltage between the drive voltage V2 and the drive voltage VC applied to the common electrode, as shown in FIG. 4. The voltage VSEG is the voltage between the drive voltage V1 and the drive voltage VC applied to the segment electrode, as shown in FIG. 4.

The power supply circuit 536 shown in FIG. 1 generates the drive voltages (V1, MV1, VC) of the SEG electrode and the drive voltages (V2, MV2, VC) of the COM electrode by boosting the voltage between the system ground power supply voltage GND and the drive voltage V1 at a boost factor corresponding to the above-described bias ratio.

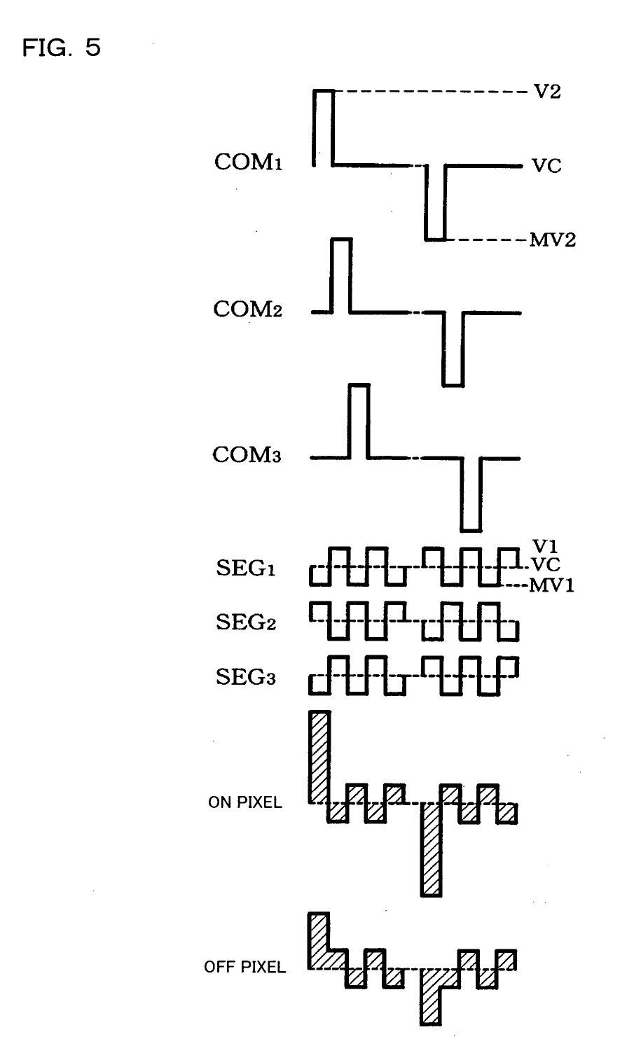

FIG. 5 is a diagram showing an example of waveforms of the COM electrode, the SEG electrode, an ON pixel, and an OFF pixel.

FIG. 5 schematically shows waveforms of the COM electrode COM₁ to COM₃ and waveforms of the SEG electrodes SEG₁ to SEG₃ when performing a polarity reversal drive in which the polarity is reversed in frame units.

The waveform of the pixel corresponding to the intersecting point of the COM electrode COM₁ and the SEG electrode SEG₁ is shown as the waveform of the ON pixel. The waveform of the pixel corresponding to the intersecting point of the COM electrode COM₁ and the SEG electrode SEG₁ is shown as the waveform of the OFF pixel. The simple matrix liquid crystal panel utilizes the properties of the liquid crystal which responds to the root-mean-square value determined by shaded areas of the ON pixel and the OFF pixel shown in FIG. 5.

2. Power Supply Circuit

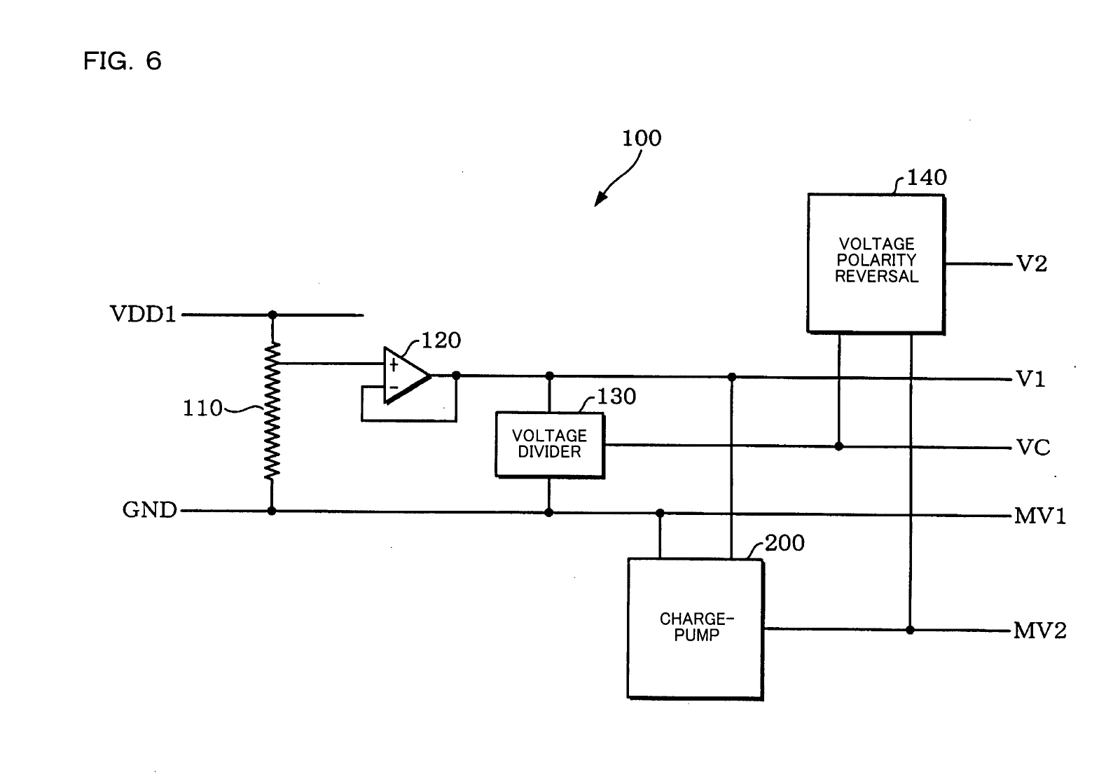

FIG. 6 is a block diagram showing a power supply circuit according to one embodiment of the present invention. A power supply circuit 100 in this embodiment may be applied as the power supply circuit 536 of the liquid crystal device shown in FIG. 1.

The power supply circuit 100 includes a resistance divider circuit 110, a regulator 120, a voltage divider circuit 130, a charge-pump circuit 200, and a voltage polarity reversal circuit 140.

The resistance divider circuit 110 is provided between a power supply voltage VDD1 and the system ground power supply voltage GND. The power supply voltage VDD1 may be generated by boosting the system power supply voltage VDD supplied from the outside in the power supply circuit 100, for example. A divided voltage obtained by dividing the voltage between the power supply voltage VDD1 and the system ground power supply voltage GND using the resistance circuit is supplied to the regulator 120. The voltage division point of the resistance divider circuit 110 can be changed based on a value set in a setting register (not shown), whereby a desired voltage between the power supply voltage VDD1 and the system ground power supply voltage GND can be supplied to the regulator 120.

The regulator 120 regulates the divided voltage supplied from the resistance divider circuit 110, and outputs the regulated voltage as the drive voltage V1. In more detail, the regulator 120 is formed by a voltage-follower-connected operational amplifier, converts the divided voltage through impedance conversion, and outputs the resulting voltage as the drive voltage V1.

The voltage divider circuit 130 is provided between the output of the regulator 120 and the system ground power supply voltage GND. The voltage divider circuit 130 outputs a divided voltage which is half of the voltage between the output voltage (drive voltage V1) of the regulator 120 and the system ground power supply voltage GND as the drive voltage VC.

The charge-pump circuit (voltage booster circuit in a broad sense) 200 generates the drive voltage MV2 based on the voltage between the output from the regulator 120 and the system ground power supply voltage GND. In more detail, the charge-pump circuit 200 generates the drive voltage MV2 by boosting the voltage between the drive voltage V1 which is the output from the regulator 120 and the system ground power supply voltage GND in the negative direction based on the system ground power supply voltage GND.

The voltage polarity reversal circuit 140 generates the drive voltage V2 obtained by reversing the polarity of the drive voltage MV2 generated by the charge-pump circuit 200 based on the drive voltage VC.

The drive voltages having the relationship shown in FIG. 4 are generated by such a power supply circuit 100.

Therefore, the power supply circuit 100 may be construed to include the charge-pump circuit 200 (voltage booster circuit), and the voltage polarity reversal circuit 140 which reverses the polarity of the drive voltage MV2 based on the voltage VC between the power supply voltage VDD1 and the system ground power supply voltage GND (voltage between a first voltage and a second voltage), and output the drive voltage MV1 (first voltage), the drive voltage V1 (second voltage), the drive voltage MV2 (boost voltage), and the drive voltage V2 (voltage obtained by reversing the polarity of the boost voltage).

Since the regulator 120 and the voltage divider circuit 130 of the power supply circuit 100 may be implemented by conventional configurations, description of the regulator 120 and the voltage divider circuit 130 is omitted.

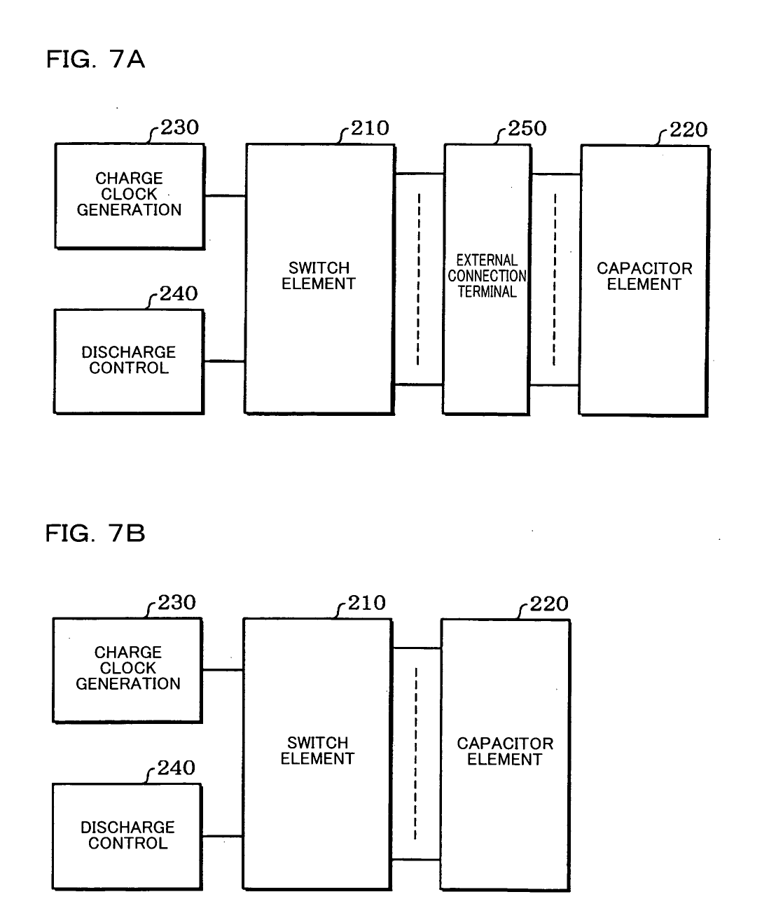

FIGS. 7A and 7B schematically show the charge-pump circuit 200.

The charge-pump circuit 200 includes a switch element 210, a capacitor element 220, a charge clock generation section 230, and a discharge control section 240. The switch element 210 includes a switch element group for performing a charge-pump operation, and a discharge switch element group for discharging an electric charge stored in a capacitor by the charge-pump operation. In this embodiment, the discharge switch element may be provided on each end of the capacitor which contributes to the charge-pump operation. The capacitor element 220 includes a capacitor element group which stores an electric charge by the charge-pump operation.

The charge clock generation section 230 generates a charge clock signal for performing the charge-pump operation of each switch element of the switch element 210. The discharge control section 240 generates a control signal for performing a discharge operation using the discharge switch element group. In this embodiment, the discharge control section 240 can separately ON/OFF control the discharge switch element.

The switch element 210 and the capacitor element 220 may be directly connected as shown in FIG. 7B, or may be connected through an external connection terminal section 250 as shown in FIG. 7A. In this case, the switch element of the switch element 210 is connected with the capacitor element of the capacitor element 220 through an external connection terminal of the external connection terminal section 250. Specifically, the charge-pump circuit 200 included in the power supply circuit 100 has a configuration in which the capacitor element 220 is omitted. In the present specification, such a charge-pump circuit 200 is also called a charge-pump circuit in a broad sense. The following description is given taking the charge-pump circuit having the configuration shown in FIG. 7A as an example.

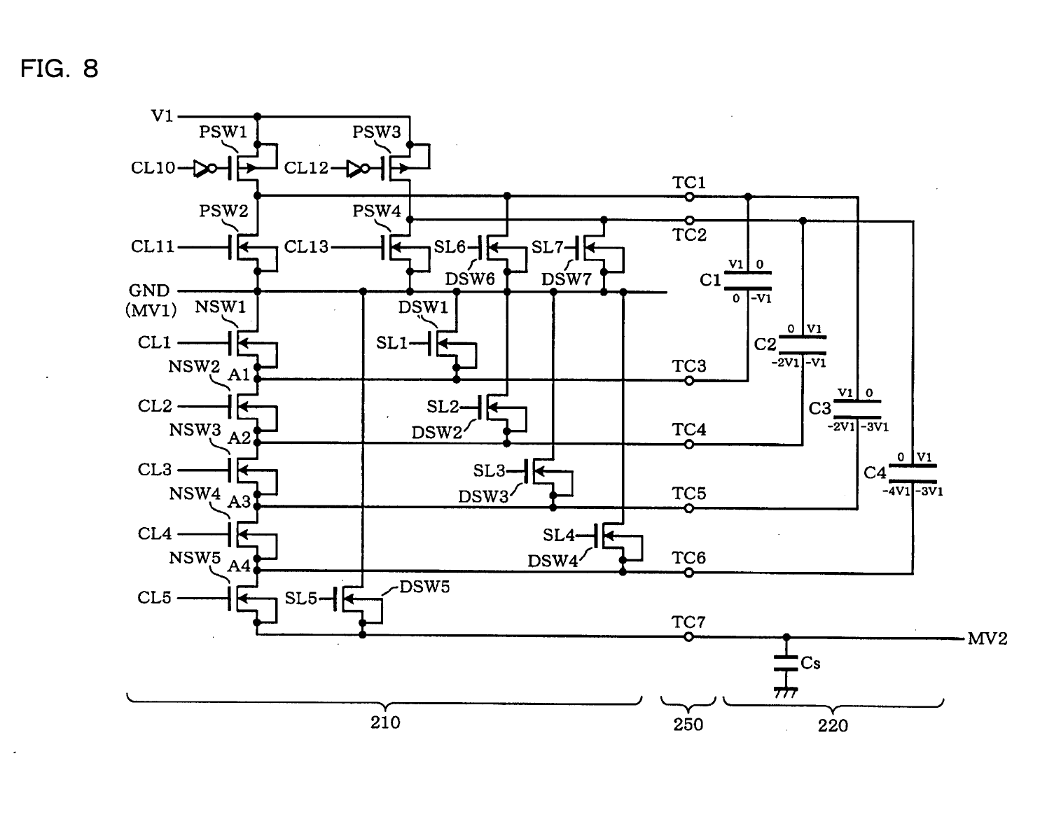

FIG. 8 shows the charge-pump circuit 200 in detail.

FIG. 8 shows a configuration of the charge-pump circuit which boosts the voltage between the drive voltage V1 and the system ground power supply voltage GND four times in the negative direction based on the ground power supply voltage GND. However, the present invention is not limited by the boost factor.

The charge-pump circuit 200 shown in FIG. 8 includes a switch element group for performing the charge-pump operation and external connection terminals TC1 to TC7, and capacitors for performing the charge-pump operation are connected outside the power supply circuit 100 (outside the liquid crystal driver when the power supply circuit 100 is applied to the liquid crystal driver). The following description is given on the assumption that a metal oxide semiconductor (MOS) transistor is used as the switch element.

The charge-pump circuit 200 includes a p-type (first conductivity type, for example) MOS transistor PSW1 and an n-type (second conductivity type, for example) MOS transistor PSW2 connected in series between the drive voltage V1 and the system ground power supply voltage GND. The charge-pump circuit 200 also includes a p-type MOS transistor PSW3 and an n-type MOS transistor PSW4 connected in series between the drive voltage V1 and the system ground power supply voltage GND. A connection node of the MOS transistors PSW1 and PSW2 is connected with one end of a capacitor connected with the external connection terminal TC1. A connection node of the MOS transistors PSW3 and PSW4 is connected with one end of a capacitor connected with the external connection terminal TC2.

The charge-pump circuit 200 further includes transistors for performing the charge-pump operation, the transistors including first to Nth (N is an integer of two or more) transistors, a first voltage being supplied to one end of the first transistor and the transistors being connected in series, and transistors for discharging an electric charge stored in capacitors connected with the first to Nth transistors, the transistors including first to Nth discharge transistors, a discharge voltage being supplied to one end of each of the discharge transistors and the other end of each of the discharge transistors being connected with a source or a drain of the kth (1≦k≦N, k is an integer) transistor. FIG. 8 shows the case where N is five.

Specifically, the charge-pump circuit 200 shown in FIG. 8 includes transistors for performing the charge-pump operation, the transistors including n-type MOS transistors NSW1 to NSW5 (first to fifth transistors), the system ground power supply voltage GND (first voltage) being supplied to one end of the n-type MOS transistor NSW1 (first transistor) and the transistors being connected in series.

In the case of forming the MOS transistors NSW1 to NSW5 in a p-type semiconductor substrate, the MOS transistors NSW1 to NSW5 may be implemented by using a triple-well structure.

The charge-pump circuit 200 includes a first discharge transistor DSW1, the system ground power supply voltage GND being supplied to one end of the first discharge transistor DSW1 and the other end being connected with a source of the MOS transistor NSW1 (drain of the MOS transistor NSW2). The first discharge transistor DSW1 may be implemented by an n-type MOS transistor to which a discharge control signal SL1 is applied at a gate electrode.

The charge-pump circuit 200 includes a second discharge transistor DSW2, the system ground power supply voltage GND being supplied to one end of the second discharge transistor DSW2 and the other end being connected with a source of the MOS transistor NSW2 (drain of the MOS transistor NSW3). The second discharge transistor DSW2 may be implemented by an n-type MOS transistor to which a discharge control signal SL2 is applied at a gate electrode. The charge-pump circuit 200 includes a third discharge transistor DSW3, the system ground power supply voltage GND being supplied to one end of the third discharge transistor DSW3 and the other end being connected with a source of the MOS transistor NSW3 (drain of the MOS transistor NSW5). The third discharge transistor DSW3 may be implemented by an n-type MOS transistor to which a discharge control signal SL3 is applied at a gate electrode. The charge-pump circuit 200 includes a fourth discharge transistor DSW4, the system ground power supply voltage GND being supplied to one end of the fourth discharge transistor DSW4 and the other end being connected with a source of the MOS transistor NSW4 (drain of the MOS transistor NSW4). The fourth discharge transistor DSW4 may be implemented by an n-type MOS transistor to which a discharge control signal SL4 is applied at a gate electrode. The charge-pump circuit 200 includes a fifth discharge transistor DSW5, the system ground power supply voltage GND being supplied to one end of the fifth discharge transistor DSW5 and the other end being connected with a source of the MOS transistor NSW5. The fifth discharge transistor DSW5 may be implemented by an n-type MOS transistor to which a discharge control signal SL5 is applied at a gate electrode.

The charge-pump circuit 200 includes a sixth discharge transistor DSW6, the system ground power supply voltage GND being supplied to one end of the sixth discharge transistor DSW6 and the other end being connected with a drain of the MOS transistor PSW2. The sixth discharge transistor DSW6 may be implemented by an n-type MOS transistor to which a discharge control signal SL6 is applied at a gate electrode. The charge-pump circuit 200 includes a seventh discharge transistor DSW7, the system ground power supply voltage GND being supplied to one end of the seventh discharge transistor DSW7 and the other end being connected with a drain of the MOS transistor PSW4. The seventh discharge transistor DSW7 may be implemented by an n-type MOS transistor to which a discharge control signal SL7 is applied at a gate electrode.

The external connection terminal TC3 is connected with a connection node of the MOS transistors NSW1 and NSW2. The external connection terminal TC4 is connected with a connection node of the MOS transistors NSW2 and NSW3. The external connection terminal TC5 is connected with a connection node of the MOS transistors NSW3 and NSW4. The external connection terminal TC6 is connected with a connection node of the MOS transistors NSW4 and NSW5. The external connection terminal TC7 is connected with a drain of the MOS transistor NSW5.

A capacitor C1 is externally connected between the external connection terminals TC1 and TC3. A capacitor C2 is externally connected between the external connection terminals TC2 and TC4. A capacitor C3 is externally connected between the external connection terminals TC1 and TC5. A capacitor C4 is externally connected between the external connection terminals TC2 and TC6. A stabilization capacitor Cs is externally connected between the external connection terminal TC7 and the system ground power supply voltage GND.

In the charge-pump circuit 200 having such a configuration, the first to seventh discharge transistors DSW1 to DSW7 are made nonconductive when the normal operation is performed, and the drive voltage MV2 is output as the boost voltage by the charge-pump operation using the MOS transistors PSW1 to PSW4 and NSW1 to NSW5 and is held by the stabilization capacitor Cs. In this case, the drive voltage MV2 is a voltage obtained by boosting the voltage between the system ground power supply voltage GND and the drive voltage V1 four times in the negative direction based on the system ground power supply voltage GND.

In order to perform the charge-pump operation during the normal operation of the charge-pump circuit 200, charge clock signals CL10 to CL13 and CL1 to CL5 are respectively supplied to gate electrodes of the MOS transistors PSW1 to PSW4 and NSW1 to NSW5. The charge clock signals CL10 to CL13 and CL1 to CL5 are generated by the charge clock generation section 230.

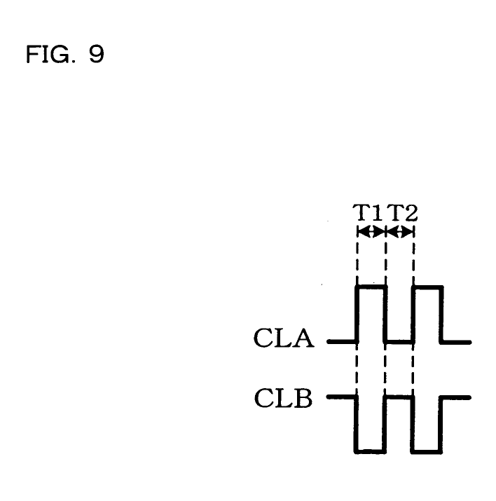

FIG. 9 illustrates the charge clock signals.

FIG. 9 shows two clock signals CLA and CLB which provide reference timings for the charge clock signals C10 to CL13 and CL1 to CL5. The phases of the clock signals CLA and CLB are the reverse of each other. For example, the clock signal CLA is set at the H level and the clock signal CLB is set at the L level in a first period T1, and the clock signal CLA is set at the L level and the clock signal CLB is set at the H level in a second period T2.

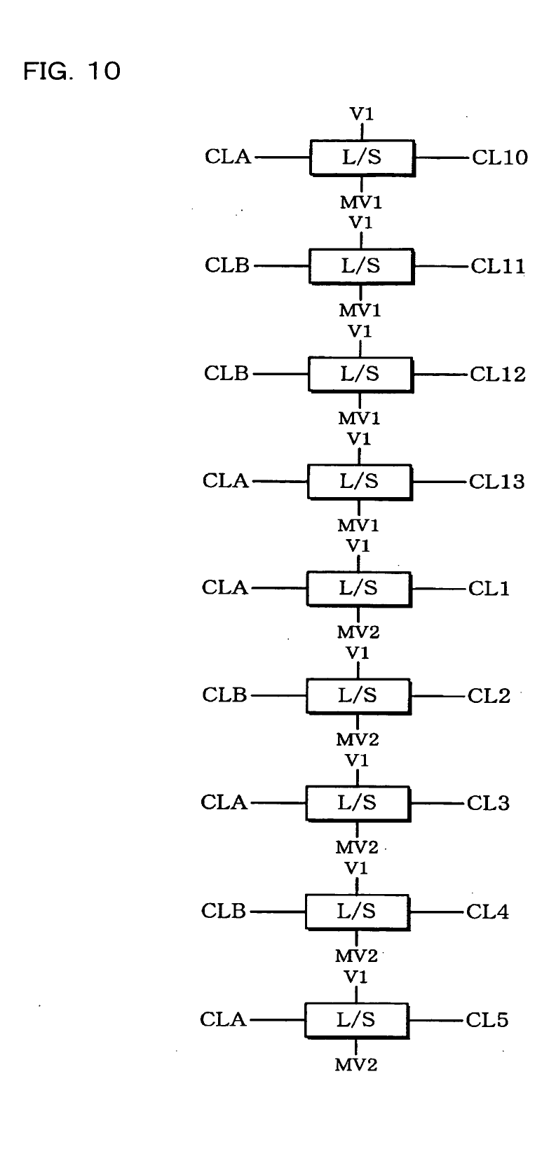

FIG. 10 shows the charge clock generation section 230.

The charge clock signals CL10 to CL13 and CL1 to CL5 are clock signals generated by converting one of the clock signals CLA and CLB to the voltage level of each MOS transistor. For example, the charge clock signal CL1 is generated as a clock signal obtained by converting the amplitude of the clock signal CLA to the amplitude of the voltage between the system ground power supply voltage GND (MV1) and the drive voltage V1. The charge clock signal CL4 is generated as a clock signal obtained by converting the amplitude of the clock signal CLB to the amplitude of the voltage between the drive voltage MV2 and the drive voltage V1.

In FIG. 8, the MOS transistor PSW1 is turned ON and the MOS transistor PSW2 is turned OFF in the first period T1, whereby one end of the capacitor C1 is connected with the drive voltage V1. In this case, since the MOS transistor NSW1 is turned ON and the MOS transistor NSW2 is turned OFF, the other end of the capacitor C1 is connected with the system ground power supply voltage GND.

In the second period T2, the MOS transistor PSW1 is turned OFF and the MOS transistor PSW2 is turned ON, whereby one end of the capacitor C1 is connected with the system ground power supply voltage GND. In this case, since the MOS transistor NSW1 is turned OFF and the MOS transistor NSW2 is turned ON, the potential (−V1) of the other end of the capacitor C1 is set at the potential of one end of the capacitor C2. In the second period T2, since the MOS transistor PSW3 is turned ON and the MOS transistor PSW4 is turned OFF, the other end of the capacitor C2 is connected with the drive voltage V1. The capacitor C2 has stored an electric charge corresponding to a voltage of “2×V1”.

Specifically, the charge-pump circuit 200 may be construed to include a transistor to which the system ground power supply voltage GND (first voltage) is supplied at one end, the transistor being the MOS transistor NSW1 (first transistor) for applying the system ground power supply voltage GND to the capacitor C1 (first capacitor), one end of the capacitor C1 having the drive voltage V1 (second voltage) in the first period T1 and the system ground power supply voltage GND in the second period T2, at the other end of the capacitor C1 in the first period T1. The charge-pump circuit 200 may be construed to further include the following MOS transistors NSW2 to NSWN (second to Nth transistors).

The MOS transistor NSW1 (ith transistor) (2≦i≦N, N is an integer greater than two, and i is an even number) is connected at one end with the other end of the MOS transistor NSW(i-1) ((i-1)th transistor), and connects the capacitor Ci (ith capacitor), one end of the capacitor Ci having the system ground power supply voltage GND in the first period T1 and the drive voltage V1 in the second period T2, with the other end of the capacitor C(i-1) ((i-1)th capacitor) at the other end of the capacitor Ci in the second period T2.

The MOS transistor NSWj (jth transistor) (3≦j≦N, j is an odd number) is connected at one end with the other end of the MOS transistor NSW(j-1) ((j-1)th transistor), and connects the capacitor Cj (jth capacitor), one end of the capacitor Cj having the drive voltage V1 in the first period T1 and the system ground power supply voltage GND in the second period T2, with the other end of the capacitor C(j-1) ((j-1)th capacitor) at the other end of the capacitor Cj in the first period T1.

FIG. 8 shows an example of the voltages applied to one end of each capacitor in the first and second periods T1 and T2.

An electric charge corresponding to a voltage of “4×V1” is stored in the capacitor C4 by repeating the above-described charge-pump operation using the capacitors in synchronization with the charge clock signals generated as shown in FIGS. 9 and 10.

The discharge control signals SL1 to SL7 for performing the discharge operation during the discharge operation of the charge-pump circuit 200 are generated by the discharge control section 240.

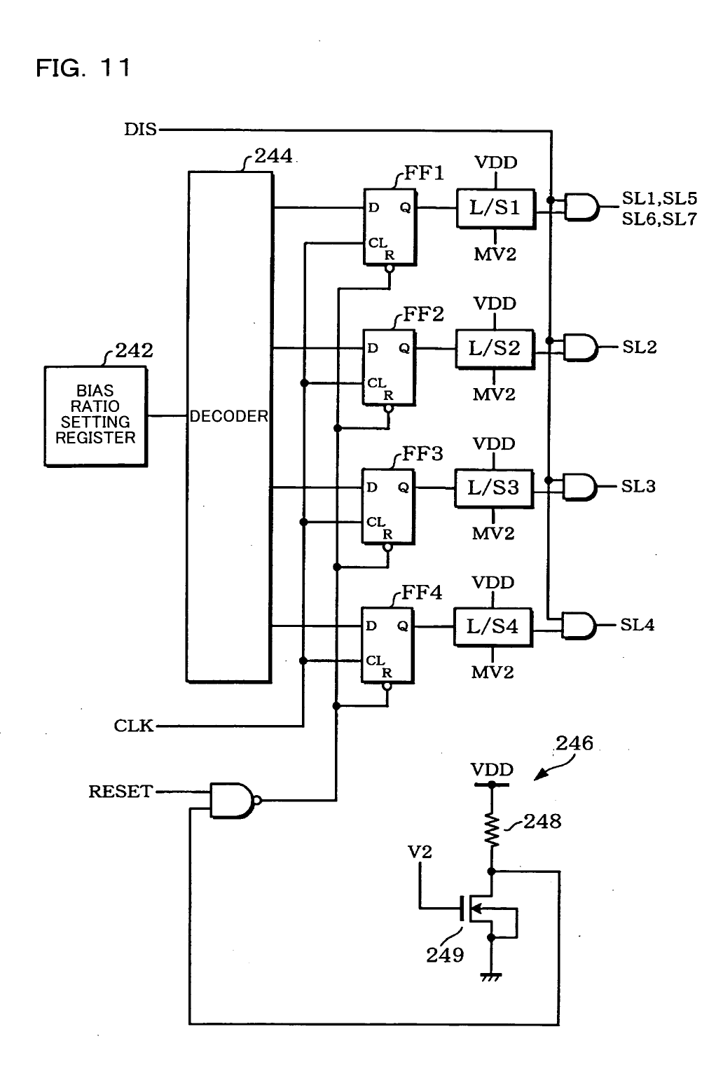

FIG. 11 shows the discharge control section 240.

The discharge control section 240 can separately make the first to Nth discharge transistors conductive or nonconductive.

Specifically, when N is five, the discharge control section 240 can separately make the first to fifth discharge transistors DSW1 to DSW5 conductive or nonconductive when the discharge operation is performed.

In more detail, the discharge control section 240 can separately make the first to fifth discharge transistors DSW1 to DSW5 conductive or nonconductive when the discharge operation is performed corresponding to the boost factor. In more detail, the discharge control section 240 includes a bias ratio setting register 242 for setting a bias ratio corresponding to the ratio obtained by the amplitude VSEG of the segment voltage applied to the segment electrode of the simple matrix liquid crystal panel and the amplitude VCOM of the common voltage applied to the common electrode, and can separately make the first to fifth discharge transistors DSW1 to DSW5 conductive or nonconductive when the discharge operation is performed based on the value set in the bias ratio setting register 242.

Therefore, the discharge control section 240 includes the bias ratio setting register 242 and a decoder 244. The decoder 244 outputs a decode result corresponding to the value set in the bias ratio setting register 242. The discharge control section 240 outputs the discharge control signals SL1 to SL7 based on the decode result from the decoder 244. In more detail, the discharge control section 240 includes flip-flops FF1 to FF4 for holding the decode result from the decoder 244, level shifters L/S1 to L/S4 for converting the voltage level of the output from each flip-flop, and a mask circuit which masks the outputs from the level shifters L/S1 to L/S4 by a discharge start signal DIS.

A clock signal input in common to the flip-flops FF1 to FF4 is an operation clock signal CLK of a logic section which generates various control signals and includes the bias ratio setting register 242. Therefore, the flip-flops FF1 to FF4 hold the decode result of the decoder 244 in synchronization with the operation clock signal CLK.

An initialization signal input in common to the flip-flops FF1 to FF4 is a NAND operation result output between a reset signal RESET of the logic section (initialization signal of the bias ratio setting register 242) and a detection signal of a voltage level drop detection circuit 246.

The voltage level drop detection circuit 246 includes a resistor element 248 which is connected at one end with the system power supply voltage VDD input from the outside, and an n-type MOS transistor 249 which is connected with the other end of the resistor element 248 at a drain. A source of the MOS transistor 249 is connected with the system ground power supply voltage GND. The drive voltage V2 is applied to a gate electrode of the MOS transistor 249. The voltage level drop detection circuit 246 outputs a detection signal at the H level when the drive voltage V2 becomes equal to or less than the threshold value of the MOS transistor 249, and outputs a detection signal at the L level when the drive voltage V2 exceeds the threshold value of the MOS transistor 249.

This prevents the initialization signal of the bias ratio setting register 242 from being reflected on the flip-flops FF1 to FF4 when the drive voltage V2 exceeds the threshold value of the MOS transistor 249. Therefore, when the discharge start signal DIS becomes active, only the discharge transistor set in the bias ratio setting register 242 can be caused to perform the discharge operation (to be made conductive).

The initialization signal of the bias ratio setting register 242 is reflected on the flip-flops FF1 to FF4 when the drive voltage V2 does not exceed the threshold value of the MOS transistor 249, whereby the values held by the flip-flops FF1 to FF4 are initialized. Therefore, when the discharge start signal DIS becomes active, the discharge transistors set in the initial state can be caused to start the discharge operation. In the case of causing all of the first to fifth discharge transistors DSW1 to DSW5 to start the discharge operation in the initial state, for example, if the discharge start signal DIS becomes active, all of the first to fifth discharge transistors DSW1 to DSW5 can be made conductive.

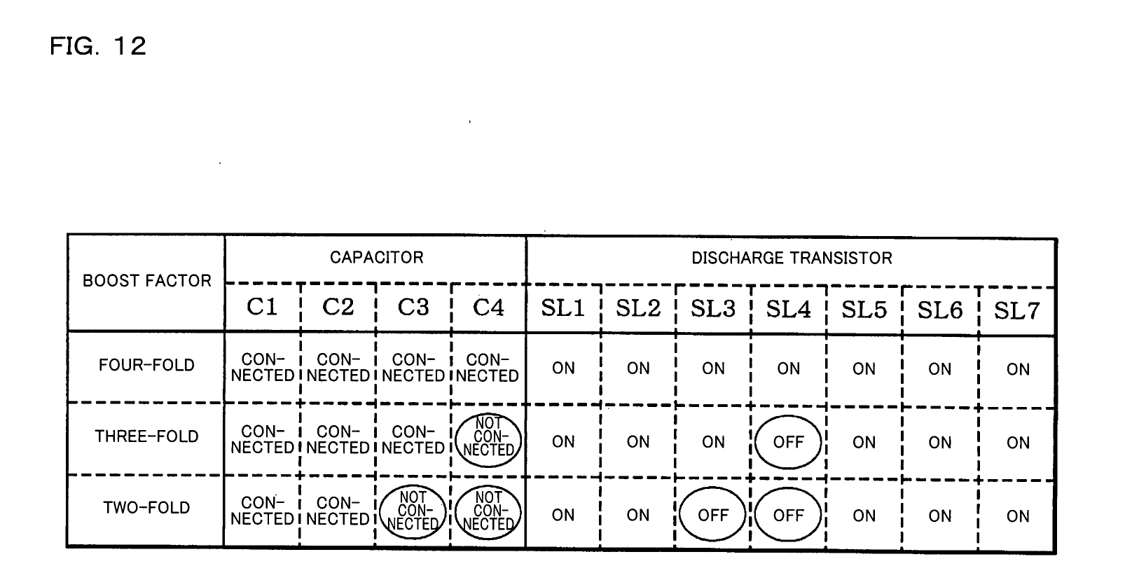

FIG. 12 is a truth table for describing the operation of the decoder 244.

The bias ratio set in the bias ratio setting register 242 may be respectively associated with the boost factor of the charge-pump circuit 200. FIG. 12 shows the presence or absence of connection of the capacitor to be connected through the external connection terminal as a flying capacitor corresponding to the boost factor and the control state of each discharge transistor during the discharge operation.

The decoder 244 outputs the decode result corresponding to each discharge transistor during the discharge operation based on the boost factor determined corresponding to the value set in the bias ratio setting register 242. In the case of a three-fold boost, the decoder 244 outputs the decode result so that the first to third and fifth to seventh discharge transistors are turned ON and the fourth discharge transistor is turned OFF during the discharge operation. The decode result is held by the flip-flops FF1 to FF4 based on the discharge start signal DIS at the start of the discharge operation, and is output as the discharge control signals SL1 to SL7.

The drive voltage MV2 generated by the charge-pump circuit 200 which can perform the above-described discharge operation is supplied to the Y driver section 534 and the voltage polarity reversal circuit 140.

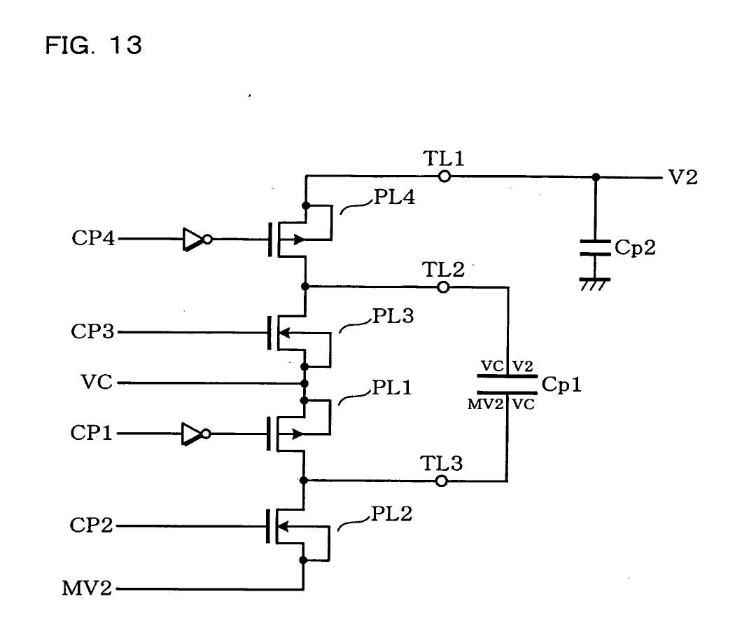

FIG. 13 shows the voltage polarity reversal circuit 140.

The voltage polarity reversal circuit 140 includes a p-type MOS transistor PL1 and an n-type MOS transistor PL2 connected in series between the drive voltages VC and MV2. The voltage polarity reversal circuit 140 includes an n-type MOS transistor PL3 and a p-type MOS transistor PL4. The p-type MOS transistor PL4 is connected with a drain of the n-type MOS transistor PL3 to which the drive voltage VC is supplied at a source.

The voltage polarity reversal circuit 140 includes external connection terminals TL1 to TL3. The external connection terminal TL1 is connected with a source of the MOS transistor PL4. The external connection terminal TL2 is connected with a connection node of the MOS transistors PL3 and PL4. The external connection terminal TL3 is connected with a connection node of the MOS transistors PL1 and PL2.

A capacitor Cp1 is externally connected between the external connection terminals TL2 and TL3. A capacitor Cp2 is externally connected between the external connection terminal TL1 and the system ground power supply voltage GND.

Charge clock signals applied to gate electrodes of the MOS transistors PL1 to PL4 may be either synchronous or asynchronous with the charge clock signals of the charge-pump circuit 200 shown in FIG. 8. The charge clock signals are supplied to the gate electrodes of the MOS transistors PL1 to PL4 so that the drive voltages VC and MV2 are applied to either end of the capacitor Cp1 in the first period T1, and the drive voltage VC is applied to the end of the capacitor to which the drive voltage MV2 has been applied in the second period T2, for example.

The power supply circuit 100 in this embodiment can generate a plurality of drive voltages having the relationship shown in FIG. 4 as described above.

3. Discharge Operation

In the charge-pump circuit 200 having the configuration shown in FIG. 8, the first to seventh discharge transistors DSW1 to DSW7 are made nonconductive when the normal operation is performed, and the drive voltage MV2 is output as a four-fold boost voltage by the charge-pump operation using the MOS transistors PSW1 to PSW4 and NSW1 to NSW5.

The charge-pump circuit 200 having such a configuration may implement a three-fold boost, a two-fold boost, and the like by omitting the connection of the capacitor.

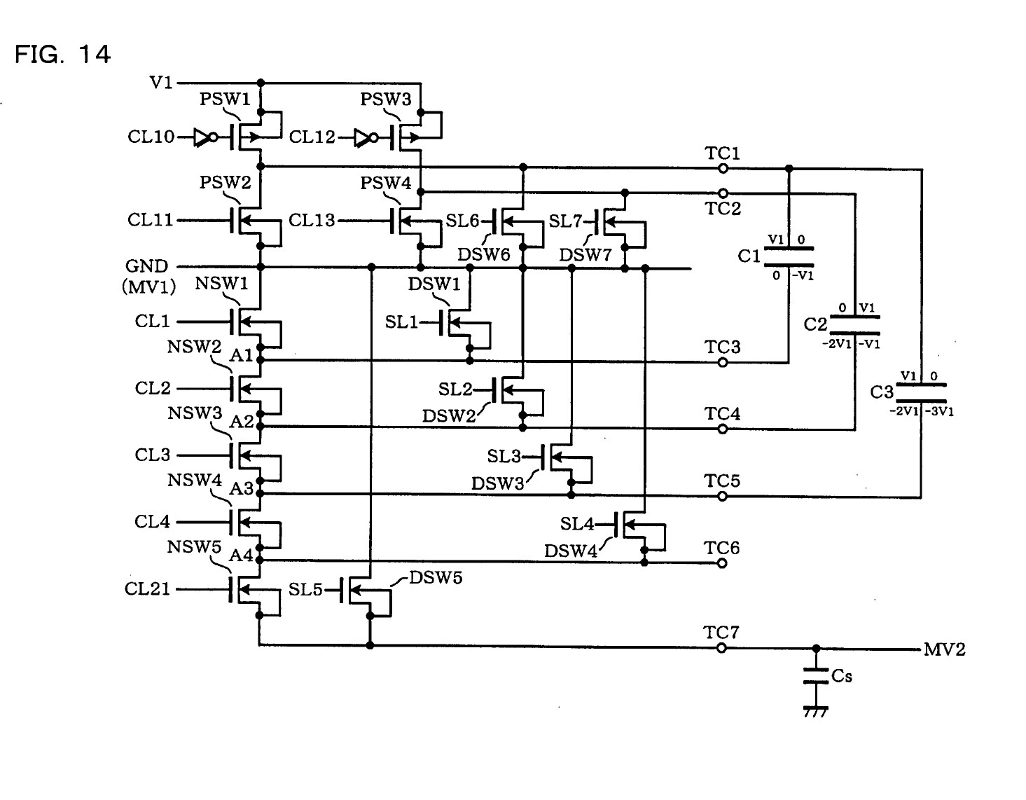

FIG. 14 shows capacitor connections of a charge-pump circuit in a three-fold boost in this embodiment.

In FIG. 14, sections the same as the sections of the charge-pump circuit 200 shown in FIG. 8 are indicated by the same symbols. Description of these sections is appropriately omitted. The charge-pump circuit shown in FIG. 14 which performs the three-fold boost differs from the charge-pump circuit shown in FIG. 8 which performs the four-fold boost in that the connection of the capacitor C4 is omitted in FIG. 14. These charge-pump circuits also differ in that a charge clock signal CL21 is supplied to the gate electrode of the MOS transistor NSW5 so that the MOS transistor NSW5 is always conductive during the normal operation.

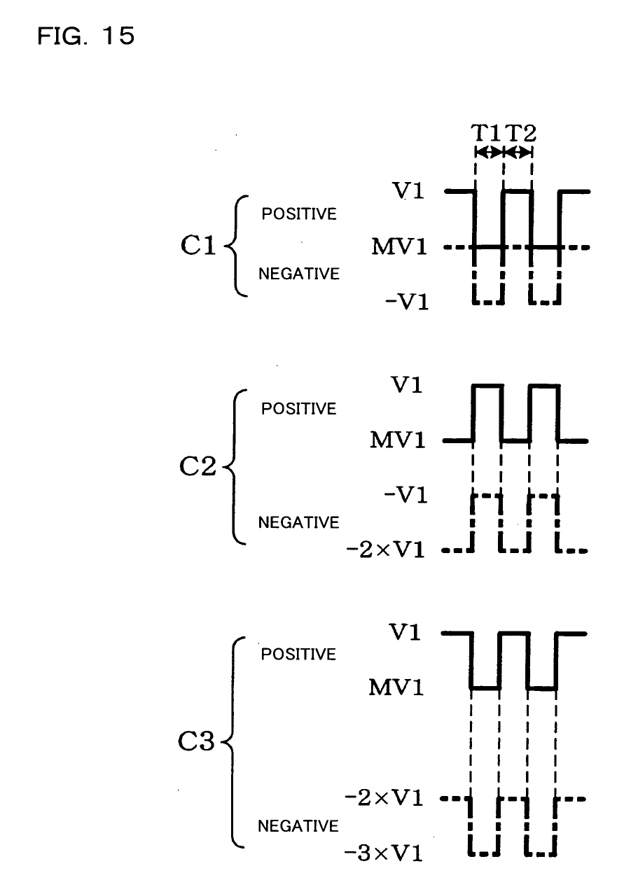

FIG. 15 shows voltage waveforms on the ends of capacitors connected to the charge-pump circuit shown in FIG. 14.

In FIG. 15, one end of the capacitor connected with one of the MOS transistors PSW1 to PSW4 is the positive side, and the other end of the capacitor connected with one of the MOS transistors NSW1 to NSW5 is the negative side.

Since the operation is the same during the three-fold boost and the four-fold boost excluding the MOS transistor NSW5, description of the operation is omitted.

The charge-pump circuit 200 having such a configuration has a triple-well structure, and an overcurrent occurs during the three-fold boost or two-fold boost unless the discharge transistors are ON/OFF controlled as described above.

This point is described below.

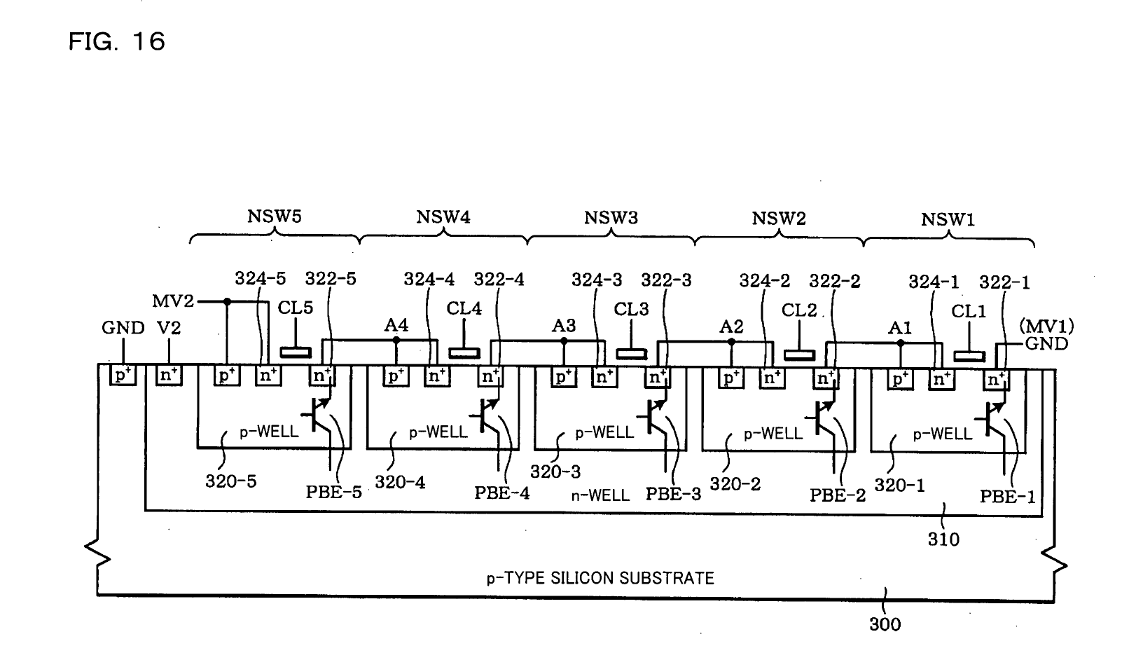

FIG. 16 is a cross-sectional view showing the MOS transistors NSW1 to NSW5 formed in a p-type semiconductor substrate. The same components in FIGS. 16 and 14 are denoted by the same reference numbers.

In the case of forming the charge-pump circuit 200 shown in FIGS. 8 and 14 on a p-type semiconductor substrate, it is necessary to use the triple-well structure.

In the case where the MOS transistors NSW1 to NSW5 are formed in a p-type (first conductivity type, for example) silicon substrate 300 (substrate in a broad sense), an n-well 310 (n-type (second conductivity type, for example) well region) is formed in the p-type silicon substrate 300. First to fifth p-wells (p-type first to fifth well regions) 320-1 to 320-5 are formed in the n-well 310. The MOS transistors NSW1 to NSW5 are respectively formed in the first to fifth p-wells 320-1 to 320-5.

The system ground power supply voltage GND is supplied to the p-type silicon substrate 300 through a p⁺ region. A reverse bias voltage is supplied to the n-well 310 through an n⁺ region for a reverse bias for the first to fifth p-wells. It is preferable that the reverse bias voltage be the highest voltage used in the power supply circuit 100 in order to prevent latchup. In FIG. 16, the drive voltage V2 shown in FIG. 4 is used as the reverse bias voltage. Therefore, the reverse bias voltage may be referred to as the high-potential-side voltage of the high-potential-side voltage and the low-potential-side voltage applied to the scan electrode of the liquid crystal panel 520. Since the drive voltage V2 is generated based on the drive voltage MV2, the reverse bias voltage may be referred to as a voltage generated based on the boost voltage.

In FIG. 16, the first to fifth p-wells 320-1 to 320-5 are formed in the n-well 310. However, the present invention is not limited thereto. The first to fifth p-wells 320-1 to 320-5 may be formed in each of n-wells separated from one another. However, the reverse bias voltage is respectively applied to the separated n-wells. n-type drain regions 322-1 to 322-5 and source regions 324-1 to 324-5 are respectively formed in the well regions formed by the first to fifth p-wells 320-1 to 320-5.

A gate electrode of the MOS transistor NSW1 (first transistor) is provided on a channel region between the drain region 322-1 and the source region 324-1 through an insulating film. A gate electrode of the MOS transistor NSW2 (second transistor) is provided on a channel region between the drain region 322-2 and the source region 324-2 through an insulating film. A gate electrode of the MOS transistor NSW3 (third transistor) is provided on a channel region between the drain region 322-3 and the source region 324-3 through an insulating film. A gate electrode of the MOS transistor NSW4 (fourth transistor) is provided on a channel region between the drain region 322-4 and the source region 324-4 through an insulating film. A gate electrode of the MOS transistor NSW5 (fifth transistor) is provided on a channel region between the drain region 322-5 and the source region 324-5 through an insulating film.

The system ground power supply voltage GND is supplied to the drain region 322-1 of the first p-well 320-1. The source region 324-(m-1) of the (m-1)th (2≦m≦5, m is an integer) p-well 320-(m-1) is electrically connected with the drain region 322-m of the mth p-well 320-m, and the voltage of the source region 324-5 of the fifth p-well 320-5 becomes the drive voltage MV2.

In FIG. 16, an npn-type first parasitic bipolar transistor element PBE-1 having the first p-well 320-1 as a base region, the n-well 310 as a collector region, and the drain region 322-1 as an emitter region is formed. An npn-type second parasitic bipolar transistor element PBE-2 having the second p-well 320-2 as a base region, the n-well 310 as a collector region, and the drain region 322-2 as an emitter region is formed. An npn-type third parasitic bipolar transistor element PBE-3 having the third p-well 320-3 as a base region, the n-well 310 as a collector region, and the drain region 322-3 as an emitter region is formed. An npn-type fourth parasitic bipolar transistor element PBE-4 having the fourth p-well 320-4 as a base region, the n-well 310 as a collector region, and the drain region 322-4 as an emitter region is formed. An npn-type fifth parasitic bipolar transistor element PBE-5 having the fifth p-well 320-5 as a base region, the n-well 310 as a collector region, and the drain region 322-5 as an emitter region is formed.

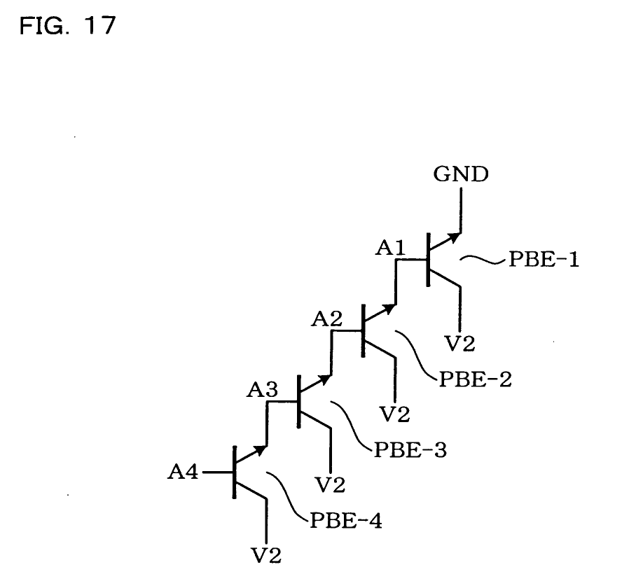

When the first to fifth discharge transistors DSW1 to DSW5 are turned ON at the same time during the discharge operation, the system ground power supply voltage GND is applied to the base region of the fourth parasitic bipolar transistor element PBE-4 through the fourth discharge transistor DSW4. As a result, the fourth parasitic bipolar transistor element PBE-4 is turned ON, whereby the first to fourth parasitic bipolar transistor elements PBE-1 to PBE-4 are Darlington-connected as shown in FIG. 17. Specifically, a current path is formed from the reverse bias voltage V2 toward the system ground power supply voltage GND by allowing the parasitic bipolar transistor elements PBE-1 to PBE-4 to be turned ON.

The current amplification factor is small even if the parasitic bipolar transistor element PBE-4 is turned ON. However, if the number of stages of Darlington connection of the parasitic bipolar transistor elements is increased due to a reduction of manufacturing process or an increase in the number of stages of the MOS transistors connected in series, the current amplification factor is increased to that extent, whereby a large current path from the n-well 310 to the system ground power supply voltage GND is formed.

Therefore, as shown in FIG. 12, occurrence of overcurrent can be prevented by blocking the current supply source when the parasitic bipolar transistor elements are Darlington-connected by causing the fourth discharge transistor DSW4 to be turned OFF during the discharge operation.

Specifically, only discharge transistors connected to the capacitors for the charge-pump operation among the first to fifth discharge transistors DSW1 to DSW5 may be made conductive during the discharge operation.

It is preferable to make the MOS transistor NSW5 conductive so that the Darlington-connected parasitic bipolar transistor elements are not formed during the discharge operation. This is because the drive voltage MV2 stored in the capacitor Cs is applied to the connection node A4, whereby the fourth parasitic bipolar transistor element PBE-4 is prevented from being turned ON.

IN the case of applying the above-described charge-pump circuit 200 ed to the power supply circuit 100, the system ground power supply voltage GND (=MV1) (first voltage) may be used as one of the voltages applied to the segment electrode of the simple matrix liquid crystal panel. The high-potential-side voltage of the high-potential-side voltage and the low-potential-side voltage applied to the common electrode of the liquid crystal panel may be used as the reverse bias voltage, and the low-potential-side voltage of the high-potential-side voltage and the low-potential-side voltage applied to the common electrode may be used as the drive voltage MV2 which is the boost voltage.

A liquid crystal driver which includes such a power supply circuit and a driver circuit which drives the segment electrode or the common electrode of the simple matrix liquid crystal panel using at least one of the system ground power supply voltage GND (first voltage), the drive voltage V2 (reverse bias voltage), and the drive voltage MV2 (boost voltage) can be provided.

4. Modification

The charge-pump circuit formed on a p-type silicon substrate is described in the above embodiment. However, the present invention is not limited thereto. A charge-pump circuit may be formed on an n-type silicon substrate. A charge-pump circuit 350 formed on an n-type silicon substrate may also be applied to the power supply circuit shown in FIG. 6 and the liquid crystal driver shown in FIG. 1. In this case, the charge-pump circuit 350 generates the drive voltage V2, and the voltage polarity reversal circuit generates the drive voltage MV2 obtained by reversing the polarity of the drive voltage V2 based on the drive voltage VC.

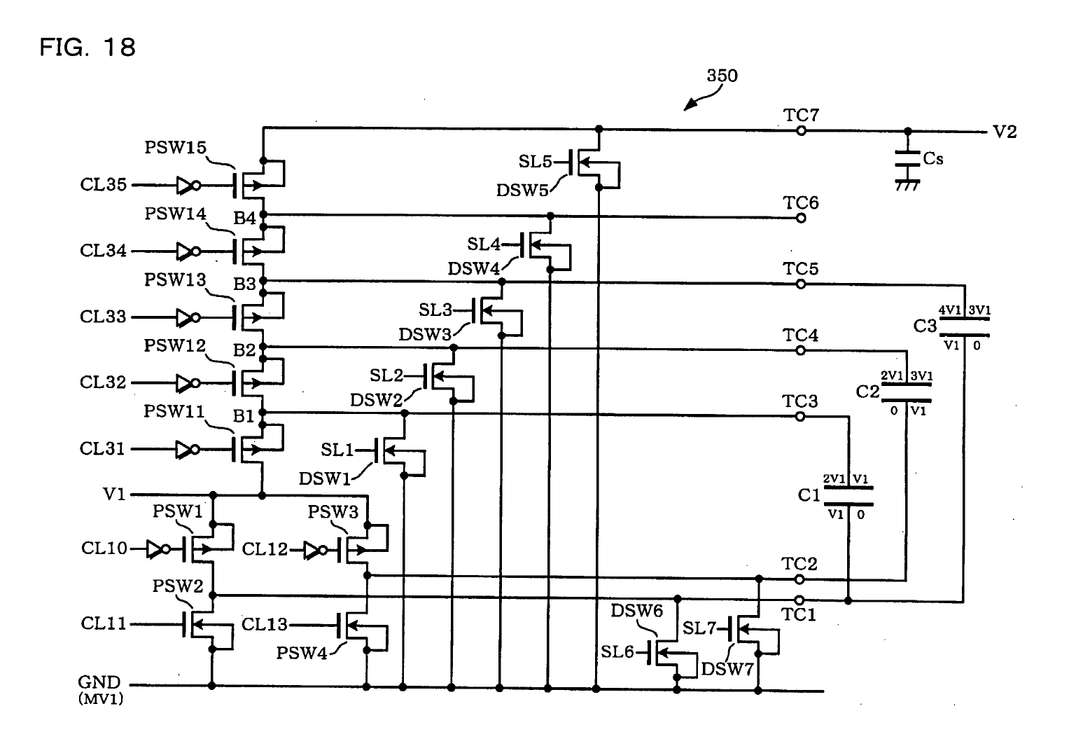

FIG. 18 is a circuit diagram showing a charge-pump circuit formed in an n-type silicon substrate.

The charge-pump circuit 350 includes a p-type MOS transistor PSW1 and an n-type MOS transistor PSW2 connected in series between the drive voltage V1 and the system ground power supply voltage GND. The charge-pump circuit 350 includes a p-type MOS transistor PSW3 and an n-type MOS transistor PSW4 connected in series between the drive voltage V1 and the system ground power supply voltage GND. A connection node of the MOS transistors PSW1 and PSW2 is connected with one end of a capacitor connected with the external connection terminal TC1. A connection node of the MOS transistors PSW3 and PSW4 is connected with one end of a capacitor connected with the external connection terminal TC2.

The charge-pump circuit 350 further includes transistors for performing the charge-pump operation, the transistors including p-type MOS transistors PSW11 to PSW15 (first to Nth transistors), the drive voltage V1 being supplied to one end of the p-type MOS transistor PSW11 and the transistors being connected in series. The charge-pump circuit 350 further includes transistors for discharging an electric charge stored in capacitors C1 to C5 connected with the MOS transistors PSW11 to PSW15, the transistors including first to fifth discharge transistors DSW1 to DSW5, the discharge voltage (system ground power supply voltage GND) being supplied to one end of each of the discharge transistors and the other end of each of the discharge transistors being connected with a source or a drain of the kth (1≦k≦5, k is an integer) transistor. FIG. 18 shows the case where N is five.

In the case of forming such MOS transistor PSW11 to PSW15 in an n-type semiconductor substrate, the MOS transistor PSW11 to PSW15 may be implemented by using the triple-well structure.

The charge-pump circuit 350 includes a first discharge transistor DSW1, the system ground power supply voltage GND being supplied to one end of the first discharge transistor DSW1 and the other end being connected with a source of the MOS transistor PSW11 (drain of the MOS transistor PSW12). The first discharge transistor DSW1 may be implemented by an n-type MOS transistor to which a discharge control signal SL1 is applied at a gate electrode.

The charge-pump circuit 350 includes a second discharge transistor DSW2, the system ground power supply voltage GND being supplied to one end of the second discharge transistor DSW2 and the other end being connected with a source of the MOS transistor PSW12 (drain of the MOS transistor PSW13). The second discharge transistor DSW2 may be implemented by an n-type MOS transistor to which a discharge control signal SL2 is applied at a gate electrode. The charge-pump circuit 350 includes a third discharge transistor DSW3, the system ground power supply voltage GND being supplied to one end of the third discharge transistor DSW3 and the other end being connected with a source of the MOS transistor PSW13 (drain of the MOS transistor PSW14). The third discharge transistor DSW3 may be implemented by an n-type MOS transistor to which a discharge control signal SL3 is applied at a gate electrode. The charge-pump circuit 350 includes a fourth discharge transistor DSW4, the system ground power supply voltage GND being supplied to one end of the fourth discharge transistor DSW4 and the other end being connected with a source of the MOS transistor PSW14 (drain of the MOS transistor PSW15). The fourth discharge transistor DSW4 may be implemented by an n-type MOS transistor to which a discharge control signal SL4 is applied at a gate electrode. The charge-pump circuit 350 includes a fifth discharge transistor DSW5, the system ground power supply voltage GND being supplied to one end of the fifth discharge transistor DSW5 and the other end being connected with a source of the MOS transistor PSW15. The fifth discharge transistor DSW5 may be implemented by an n-type MOS transistor to which a discharge control signal SL5 is applied at a gate electrode.

The charge-pump circuit 350 includes a sixth discharge transistor DSW6, the system ground power supply voltage GND being supplied to one end of the sixth discharge transistor DSW6 and the other end being connected with a drain of the MOS transistor PSW2. The sixth discharge transistor DSW6 may be implemented by an n-type MOS transistor to which a discharge control signal SL6 is applied at a gate electrode. The charge-pump circuit 350 includes a seventh discharge transistor DSW7, the system ground power supply voltage GND being supplied to one end of the seventh discharge transistor DSW7 and the other end being connected with a drain of the MOS transistor PSW4. The seventh discharge transistor DSW7 may be implemented by an n-type MOS transistor to which a discharge control signal SL7 is applied at a gate electrode.

An external connection terminal TC3 is connected with a connection node of the MOS transistors PSW11 and PSW12. An external connection terminal TC4 is connected with a connection node of the MOS transistors PSW12 and PSW13. An external connection terminal TC5 is connected with a connection node of the MOS transistors PSW13 and PSW14. An external connection terminal TC6 is connected with a connection node of the MOS transistors PSW14 and PSW15. An external connection terminal TC7 is connected with a source of the MOS transistor PSW15.

A capacitor C1 is externally connected between the external connection terminals TC1 and TC3. A capacitor C2 is externally connected between the external connection terminals TC2 and TC4. A capacitor C3 is externally connected between the external connection terminals TC1 and TC5. Although not shown in FIG. 18, a capacitor C4 may be externally connected between the external connection terminals TC2 and TC6 in order to increase the boost factor. A stabilization capacitor Cs is externally connected between the external connection terminal TC7 and the system ground power supply voltage GND.

The charge-pump circuit 350 having such a configuration performs the charge-pump operation in synchronization with two-phase charge clock signals in the same manner as shown in FIGS. 8 and 14. Therefore, description of the charge-pump operation is omitted.

Since the triple-well structure is used in the same manner as in the charge-pump circuit 200, parasitic bipolar transistor elements are formed.

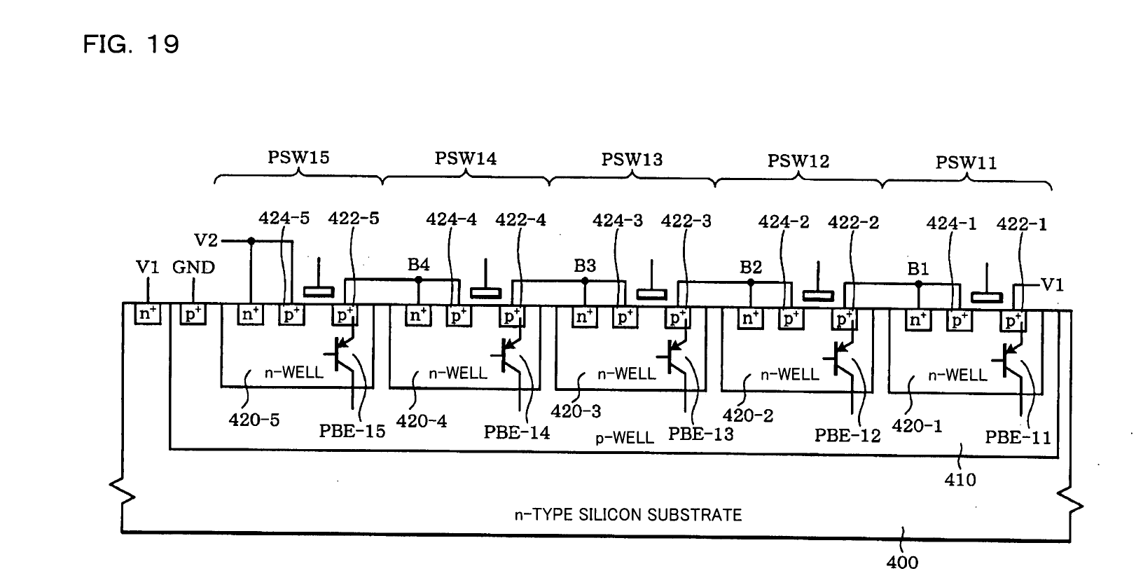

FIG. 19 is a cross-sectional view showing the MOS transistors PSW11 to PSW15 formed in an n-type semiconductor substrate. The same components in FIGS. 18 and 19 are denoted by the same reference numbers.

A p-well 410 (p-type well region) is formed in an n-type silicon substrate 400. First to fifth n-wells 420-1 to 420-5 (n-type first to fifth well regions) are formed in the p-well 410. The MOS transistors PSW11 to PSW15 are formed in the first to fifth n-wells 420-1 to 420-5.

The drive voltage V1 is supplied to the n-type silicon substrate 400 through an n⁺ region, for example. A reverse bias voltage is supplied to the p-well 410 through a p⁺ region for a reverse bias for the first to fifth n-wells. It is preferable that the reverse bias voltage be the lowest voltage used in the power supply circuit 100 in order to prevent latchup. For example, the drive voltage MV2 or the system ground power supply voltage GND shown in FIG. 4 may be used as the reverse bias voltage. In this case, the reverse bias voltage may be referred to as the low-potential-side voltage of the high-potential-side voltage and the low-potential-side voltage applied to the scan electrode of the liquid crystal panel 520. Since the drive voltage MV2 is generated based on the drive voltage V2, the reverse bias voltage may be referred to as a voltage generated based on the boost voltage.

In FIG. 19, the first to fifth n-wells 420-1 to 420-5 are formed in the p-well 410.

However, the present invention is not limited thereto. The first to fifth n-wells 420-1 to 420-5 may be respectively formed in p-wells separated from one another. However, the reverse bias voltage is applied to each of the separated p-wells.

p-type source regions 424-1 to 424-5 and drain regions 422-1 to 422-5 are respectively formed in the well regions formed by the first to fifth n-wells 420-1 to 420-5.

A gate electrode of the MOS transistor PSW11 (first transistor) is provided on a channel region between the source region 424-1 and the drain region 422-1 through an insulating film. A gate electrode of the MOS transistor PSW12 (second transistor) is provided on a channel region between the source region 424-2 and the drain region 422-2 through an insulating film. A gate electrode of the MOS transistor PSW13 (third transistor) is provided on a channel region between the source region 424-3 and the drain region 422-3 through an insulating film. A gate electrode of the MOS transistor PSW14 (fourth transistor) is provided on a channel region between the source region 424-4 and the drain region 422-4 through an insulating film. A gate electrode of the MOS transistor PSW15 (fifth transistor) is provided on a channel region between the source region 424-5 and the drain region 422-5 through an insulating film.

The drive voltage V1 is supplied to the drain region 422-1 of the first n-well 420-1. The source region 424-(m-1) of the (m-1)th (2≦m≦5, m is an integer) n-well 420-(m-1) is electrically connected with the drain region 422-m of the mth n-well 420-m, and the voltage of the source region 424-5 of the fifth n-well 420-5 is output as the drive voltage V2.

In FIG. 19, a pnp-type first parasitic bipolar transistor element PBE-11 having the first n-well 420-1 as a base region, the p-well 410 as a collector region, and the drain region 422-1 as an emitter region is formed. A pnp-type second parasitic bipolar transistor element PBE-12 having the second n-well 420-2 as a base region, the p-well 410 as a collector region, and the drain region 422-2 as an emitter region is formed. A pnp-type third parasitic bipolar transistor element PBE-13 having the third n-well 420-3 as a base region, the p-well 410 as a collector region, and the drain region 422-3 as an emitter region is formed. A pnp-type fourth parasitic bipolar transistor element PBE-14 having the fourth n-well 420-4 as a base region, the p-well 410 as a collector region, and the drain region 422-4 as an emitter region is formed. A pnp-type fifth parasitic bipolar transistor element PBE-15 having the fifth n-well 420-5 as a base region, the p-well 410 as a collector region, and the drain region 422-5 as an emitter region is formed.

Therefore, during the discharge operation for discharging an electric charge stored in the capacitor of the charge-pump circuit 350 when removing electric power, when the discharge transistors DSW1 to DSW7 are turned ON at the same time, the voltage of the connection node B4 of the MOS transistors PSW14 and PSW15 is set at the system ground power supply voltage GND.

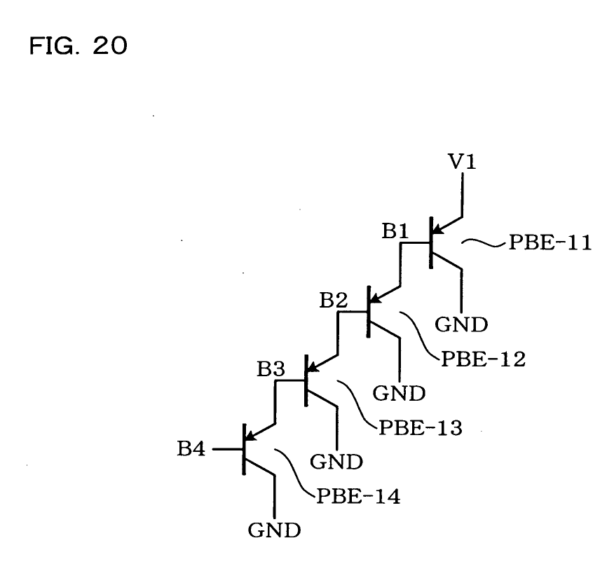

This causes the base region of the parasitic bipolar transistor element PBE-14 to be set at the system ground power supply voltage GND or the drive voltage V1. As a result, since the fourth parasitic bipolar transistor element PBE-4 is turned ON, the first to fourth parasitic bipolar transistor elements PBE-11 to PBE-14 are Darlington-connected as shown in FIG. 20, whereby a current path is formed.

Therefore, as shown in FIG. 12, occurrence of overcurrent can be prevented by blocking the current supply source when the parasitic bipolar transistor elements are Darlington-connected by causing the fourth discharge transistor DSW4 to be turned OFF during the discharge operation in the same manner as in this embodiment.

Specifically, only discharge transistors connected to the capacitors for the charge-pump operation among the first to fifth discharge transistors DSW1 to DSW5 may be made conductive during the discharge operation.

Although only some embodiments of the present invention have been described in detail above, those skilled in the art will readily appreciate that many modifications are possible in the embodiments without departing from the novel teachings and advantages of this invention. Accordingly, all such modifications are intended to be included within the scope of this invention. For example, the present invention may be applied not only to drive the liquid crystal panel, but also to drive an electroluminescent device or plasma display device.

The present invention is not limited to the configurations described in the above embodiment or modification, and various configurations equivalent to these configurations may be employed.

Part of requirements of any claim of the present invention could be omitted from a dependent claim which depends on that claim. Moreover, part of requirements of any independent claim of the present invention could be made to depend on any other independent claim.

1. A voltage booster circuit which uses an electric charge stored in a capacitor by a charge-pump operation to generate a boost voltage, the voltage booster circuit comprising:
first to Nth transistors (N is an integer greater than one) which are connected in series and used for the charge-pump operation, a first voltage being supplied to one end of the first transistor; and
first to Nth discharge transistors used for discharging an electronic charge stored in capacitors connected to the first to Nth transistors, a discharge voltage being supplied to one end of each of the first to Nth discharge transistors, and the other end of each of the first to Nth discharge transistors being connected to a source side or a drain side of the kth transistors among the first to Nth transistors (1≦k≦N, k is an integer),
wherein the first to Nth transistors are respectively formed in first to Nth well regions of a first conductivity type formed in a well region of a second conductivity type in a semiconductor substrate of the first conductivity type;
wherein a reverse bias voltage for the first to Nth well regions is applied to the well region of the second conductivity type;
wherein each of the first to Nth well regions includes source and drain regions of the second conductivity type;
wherein a gate electrode of each of the first to Nth transistors is disposed on a channel region with an insulating film interposed, the channel region being disposed between the source and drain regions;
wherein the first voltage is supplied to the drain region or the source region of the first well region, the drain region or the source region of an (m-1)th well region (2≦m≦N, m is an integer) among the first to Nth well regions is electrically connected to the source region or the drain region of the mth well region, and a voltage of the drain region or the source region of the Nth well region is output as the boost voltage; and
wherein, when a discharge operation is performed, the first to Nth discharge transistors are separately made conductive or nonconductive.

2. The voltage booster circuit as defined in claim 1,
wherein the first transistor has one end to which the first voltage is supplied, and applies the first voltage to one end of a first capacitor in a first period, the other end of the first capacitor having a second voltage in the first period and having the first voltage in a second period;
wherein the ith transistor (2≦i≦N, N is an integer greater than two and i is an even number) has one end connected to one end of an (i-1)th transistor, and connects one end of an ith capacitor to one end of an (i-1)th capacitor in the second period, the other end of the ith capacitor having the first voltage in the first period and having the second voltage in the second period; and
wherein the jth transistor (3≦j≦N, and j is an odd number) has one end connected to one end of a (j-1)th transistor, and connects one end of a jth capacitor to one end of the (j-1)th capacitor in the first period, the other end of the jth capacitor having the second voltage in the first period and having the first voltage in the second period.

3. The voltage booster circuit as defined in claim 1,
wherein, when the discharge operation is performed, each of the first to Nth discharge transistors is made conductive or nonconductive, depending on a boost factor.

4. The voltage booster circuit as defined in claim 3, further comprising:
a bias ratio setting register which sets a bias ratio obtained by an amplitude of a common voltage and an amplitude of a segment voltage, the common voltage being applied to a common electrode of a simple matrix liquid crystal panel, and the segment voltage being applied to a segment electrode of the simple matrix liquid crystal panel,
wherein, when the discharge operation is performed, each of the first to Nth discharge transistors is made conductive or nonconductive based on a value set in the bias ratio setting register.

5. The voltage booster circuit as defined in claim 4,
wherein all of the first to Nth discharge transistors are made conductive on condition that an initialization signal of the bias ratio setting register has become active and the reverse bias voltage has become equal to or less than a threshold value.

6. The voltage booster circuit as defined in claim 1,
wherein, when the discharge operation is performed, only a discharge transistor connected to a capacitor for performing the charge-pump operation is made conductive, among the first to Nth discharge transistors.

7. The voltage booster circuit as defined in claim 1, wherein the discharge voltage is the first voltage.

8. A power supply circuit, comprising:
the voltage booster circuit as defined in claim 1; and
a voltage polarity reversal circuit which reverses the polarity of the boost voltage based on a voltage between the first voltage and a second voltage,
wherein the power supply circuit outputs the first voltage, the second voltage, the boost voltage, and a voltage obtained by reversing the polarity of the boost voltage.

9. The power supply circuit as defined in claim 8,
wherein the voltage obtained by reversing the polarity of the boost voltage is the reverse bias voltage.

10. The power supply circuit as defined in claim 8,
wherein the first voltage is one of voltages applied to a segment electrode of a simple matrix liquid crystal panel;
wherein the reverse bias voltage is one of a high-potential-side voltage and a low-potential-side voltage applied to a common electrode of the liquid crystal panel; and
wherein the boost voltage is the other of the high-potential-side voltage and the low-potential-side voltage.

11. A liquid crystal driver, comprising:
the power supply circuit as defined in claim 8; and
a driver circuit which drives a segment electrode or a common electrode of a simple matrix liquid crystal panel by using at least one of the first voltage, the reverse bias voltage, and the boost voltage.
